(19) United States
(12) Patent Application Publication
(10) Pub. No.: US 2025/0194684 A1
(43) Pub. Date: Jun. 19, 2025

(54) AEROSOL GENERATOR SUITABLE FOR LIQUID MATRIX, AND ATOMIZATION UNIT

(71) Applicant: SHENZHEN FIRST UNION TECHNOLOGY CO., LTD., Shenzhen, Guangdong (CN)

(72) Inventors: Zhiming LU, Shenzhen, Guangdong (CN); Ruilong HU, Shenzhen, Guangdong (CN); Zhongli XU, Shenzhen, Guangdong (CN); Yonghai LI, Shenzhen, Guangdong (CN)

(73) Assignee: SHENZHEN FIRST UNION TECHNOLOGY CO., LTD., Shenzhen, Guangdong (CN)

(21) Appl. No.: 18/845,738

(22) PCT Filed: Mar. 9, 2023
(86) PCT No.: PCT/CN2023/080583

§ 371 Date: Sep. 10, 2024

(30) Foreign Application Priority Data
Mar. 11, 2022 (CN) 202220567107.4

(51) Int. Cl. A24F 40/465; A24F 40/10; A24F 40/44; A24F 40/51; H05B 6/10

(52) U.S. Cl. CPC A24F 40/465; A24F 40/10; A24F 40/44; A24F 40/51; H05B 6/108

(57) ABSTRACT

An aerosol generator suitable for a liquid matrix, and an atomization unit are provided. The aerosol generator includes: a liquid storage cavity for storing a liquid matrix; a magnetic field generator for generating a changing magnetic field when power is supplied; and an atomization unit for atomizing the liquid matrix to generate an aerosol. The atomization unit includes: a porous body having a first surface and a second surface opposite to the first surface; and at least one sensor embedded in the porous body and located between the first surface and the second surface. The sensor is penetrated by the changing magnetic field to generate heat, to atomize the liquid matrix, and the porous body absorbs the liquid matrix through the first surface and guides the liquid matrix to pass through or avoid the sensor, to transfer toward the second surface.

### CROSS-REFERENCE TO RELATED APPLICATIONS

This application claims priority to Chinese Patent Application No. 202220567107.4, filed with the China National Intellectual Property Administration on Mar. 11, 2020 and entitled “AEROSOL GENERATOR SUITABLE FOR LIQUID MATRIX, AND ATOMIZATION UNIT”, which is incorporated herein by reference in its entirety.

### TECHNICAL FIELD

This application relates to the field of electronic atomization technologies, and in particular, to an aerosol generator suitable for a liquid matrix, and an atomization unit.

### BACKGROUND

An aerosol generator is an electronic product that generates an aerosol for a user to inhale by heating a liquid matrix. The aerosol generator generally includes two parts: an atomizer and a power supply assembly. For example, a suitable liquid matrix includes a nicotine salt solution, an agent, a plant extract solution, and the like. As an example of the related art, the liquid matrix is stored in the atomizer and an atomization unit configured to heat the liquid matrix is arranged in the atomizer, and the power supply assembly includes a battery and a circuit board.

A typical atomization unit is of a ceramic core structure in which a heating wire and a porous ceramic are integrally formed. The power supply assembly may supply power to the heating wire to generate heat, so as to generate high temperature to heat the liquid matrix. A problem with the atomization unit is low heating efficiency and slow smoke emission speed. In addition, in some usage scenarios, a temperature field provided by the heating wire through an own resistance heating is unevenly distributed, to easily cause local temperature of the atomization unit to be too high, which is not good for taste experience of the user to inhale an aerosol.

### SUMMARY

This application provides an aerosol generator suitable for a liquid matrix, and an atomization unit, aiming to solve a problem of low heating efficiency and slow smoke emission speed of an existing atomization unit.

According to one aspect of this application, an aerosol generator suitable for a liquid matrix is provided, including:
a liquid storage cavity, configured to store a liquid matrix;
a magnetic field generator, configured to generate a changing magnetic field when power is supplied; and
an atomization unit, configured to atomize the liquid matrix to generate an aerosol, where the atomization unit includes:
a porous body, having a first surface and a second surface opposite to the first surface; and
at least one sensor, embedded in the porous body and located between the first surface and the second surface, where the sensor is configured to be penetrated by the changing magnetic field to generate heat, to atomize the liquid matrix, and
the porous body is configured to absorb the liquid matrix through the first surface and guide the liquid matrix to pass through or avoid the sensor, to transfer toward the second surface.

According to another aspect of this application, an atomization unit for an aerosol generator is provided, including:
a porous body, having a first surface and a second surface opposite to the first surface; and
at least one sensor, embedded in the porous body and located between the first surface and the second surface, where the sensor is configured to be penetrated by the changing magnetic field to generate heat, to atomize the liquid matrix, and
the porous body is configured to absorb the liquid matrix through the first surface and guide the liquid matrix to pass through or avoid the sensor, to transfer toward the second surface.

The atomization unit is penetrated by the changing magnetic field through the sensor embedded in the porous body to generate heat, to atomize the liquid matrix. In comparison with an existing atomization unit, heating efficiency is high and smoke emission speed is fast.

### BRIEF DESCRIPTION OF THE DRAWINGS

One or more embodiments are exemplarily described with reference to the corresponding figures in the accompanying drawings, and the descriptions are not to be construed as limiting embodiments. Elements in the accompanying drawings that have same reference numerals are represented as similar elements, and unless otherwise particularly stated, the figures in the accompanying drawings are not drawn to scale.

FIG. 1 is a schematic diagram of an aerosol generator according to an implementation of this application;

FIG. 2 is a schematic diagram of an atomization unit according to an implementation of this application;

FIG. 3 is a schematic cross-sectional view of an atomization unit according to an implementation of this application;

FIG. 4 is a schematic diagram of a sensor according to an implementation of this application;

FIG. 5 is a schematic diagram of another atomization unit according to an implementation of this application;

FIG. 6 is a schematic cross-sectional view of another atomization unit according to an implementation of this application;

FIG. 7 is a schematic diagram of another sensor according to an implementation of this application; and

FIG. 8 is a schematic diagram of still another atomization unit according to an implementation of this application.

### DETAILED DESCRIPTION

To make objectives, technical solutions, and advantages in embodiments of this application clearer, the technical solutions in embodiments of this application are clearly and completely described below with reference to the accompanying drawings in embodiments of this application. Apparently, the described embodiments are some rather than all of embodiments of this application. It should be understood that the specific embodiments described herein are merely used to explain this application but are not intended to limit this application. All other embodiments obtained by a person of ordinary skill in the art based on embodiments of this application without creative efforts shall fall within the protection scope of this application.

It should be noted that, when an element is expressed as “being fixed to” another element, the element may be directly on the another element, or one or more intermediate elements may exist between the element and the another element. When an element is expressed as “being connected to” another element, the element may be directly connected to the another element, or one or more intermediate elements may exist between the element and the another element.

The terms “vertical”, “horizontal”, “left”, “right”, and similar expressions used in this specification are merely used for description.

In addition, technical features involved in embodiments of this application that are described below may be combined with each other provided that no conflict occurs.

### Embodiment 1

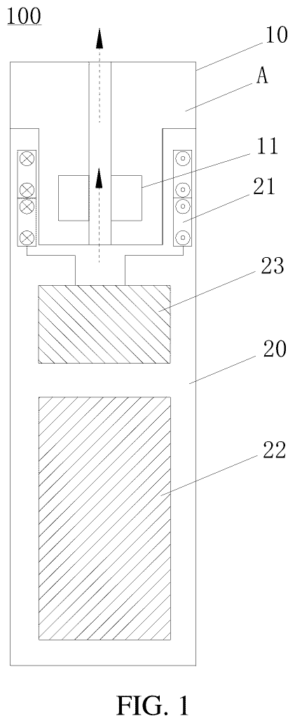

FIG. 1 is a schematic diagram of an aerosol generator according to an implementation of this application.

As shown in FIG. 1, an aerosol generator 100 includes an atomizer 10 and a power supply assembly 20. The atomizer 10 and the power supply assembly 20 may be formed integrally or separately. For example, the atomizer 10 may be in snap-fit connection, magnetic connection, and the like to the power supply assembly 20.

The atomizer 10 includes an atomization unit 11 and a liquid storage cavity A. The liquid storage cavity A is configured to store an atomizable liquid matrix. The atomization unit 11 is configured to be inductively coupled to a magnetic field generator 21 to generate heat when penetrated by a changing magnetic field, to further heat and atomize the liquid matrix to generate an aerosol for inhalation.

The power supply assembly 20 includes the magnetic field generator 21, a battery cell 22, and a circuit 23.

The magnetic field generator 21 generates the changing magnetic field under an alternating current. In another example, the magnetic field generator 21 may be disposed in the atomizer 10.

The battery cell 22 supplies power for operating the aerosol generator 100. The battery cell 22 may be a rechargeable battery cell or a disposable battery cell.

The circuit 23 may control an overall operation of the aerosol generator 100. The circuit 23 controls not only operations of the battery cell 22 and the atomization unit 11, but also an operation of another element in the aerosol generator 100.

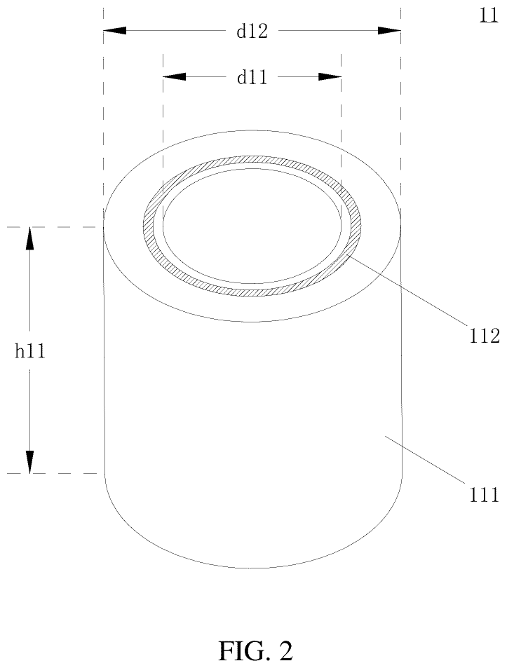

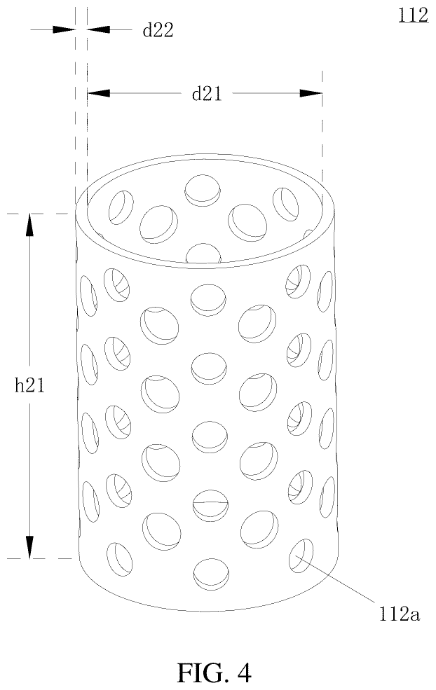

As shown in FIG. 2 to FIG. 4, implementations of this application provide an atomization unit 11. The atomization unit 11 includes a porous body 111 and a sensor 112.

The porous body 111 includes a porous ceramic. A material of the porous ceramic includes at least one of alumina, zirconia, kaolinite, diatomite, or montmorillonite. A porosity of the porous ceramic may be adjusted within a range of 10% to 90%, and an average aperture may be adjusted within a range of 10 μm to 150 μm. In some embodiments, adjustments may be performed by, for example, an addition quantity of pore-forming agents and selection of a particle size of a pore-forming agent.

The porous body 111 is in a shape of a hollow cylinder, an outer wall of the porous body 111 defines a liquid absorbing surface 111a (a first surface) for absorbing the liquid matrix, and an inner wall of the porous body 111 defines an atomization surface 111b (a second surface). A hollow portion defines an aerosol channel, and an atomized aerosol together with air may flow toward a mouthpiece of the aerosol generator 100. The porous body 111 has an inner diameter d11 ranging from 0.2 mm to 20 mm, an outer diameter d12 ranging from 1 mm to 30 mm, and a height h11 ranging from 0.5 mm to 50 mm.

The sensor 112 is configured to be penetrated by a changing magnetic field to generate heat. The sensor 112 is integrally formed with the porous body 111 and embedded in the porous body 111. For example, the sensor 112 may be co-fired with the porous body 111 to form the atomization unit 11. In this case, the liquid matrix does not need to contact a surface of the sensor 112 to be atomized, but begins to be atomized when being heated near the sensor 112. In this way, thermal contact between the sensor 112 and the porous body 111 avoids dry burning. In addition, most of liquid matrices do not directly contact the sensor 112 during atomization, to avoid metal contamination of the sensor 112.

A material of the sensor 112 may be selected as a metal material. Preferably, a metal material with good magnetic conductivity and including at least one of iron, cobalt, or nickel may be selected.

A shape of the sensor 112 fits that of the porous body 111 and is substantially in a closed-loop tubular shape. Specifically, the sensor 112 is in a shape of a hollow cylinder, and has an inner diameter d21 ranging from 1 mm to 20 mm, a wall thickness d22 ranging from 0.1 mm to 2 mm, and a height h21 ranging from 0.5 mm to 50 mm. The sensor 112 has a plurality of through holes 112a arranged at intervals. Apertures of the through holes are 0.1 mm to 0.5 mm. The liquid matrix may pass through or avoid the sensor 112 through the through holes 112a, to transfer toward the atomization surface. The through holes 112a may also increase a binding force between an inner side wall and an outer side wall of a co-fired porous ceramic, to improve overall strength of the atomization unit 11. Shapes of the through holes 112a may be circular, elliptical, triangular, diamond, or other regular or irregular shapes.

In a preferred implementation, density of the through holes 112a is unevenly distributed in a longitudinal extension direction of the sensor 112, or the apertures of the through holes 112a in different areas are inconsistent. Such uneven distribution of positions of the through holes or inconsistent aperture distribution causes the heat generated by the sensor 112 in a magnetic field to be also unevenly distributed. Generally, heat in an area with small density of the through holes 112a is high, and heat in an area with large density of the through holes 112a is low. For example, in an implementable example, density of the through holes 112a in an upper half of the sensor is small, while density of the through holes 112a in a lower half of the sensor is large. In another example, density of the through holes 112a near two end areas of the sensor in a longitudinal direction is small or apertures of the through holes 112a are small, while density of the through holes 112a located in a middle area in the longitudinal direction is large or apertures of the through holes 112a are large. In this case, temperature field distribution of the atomization unit in the longitudinal direction can be balanced by adjusting the positions or sizes of the through holes.

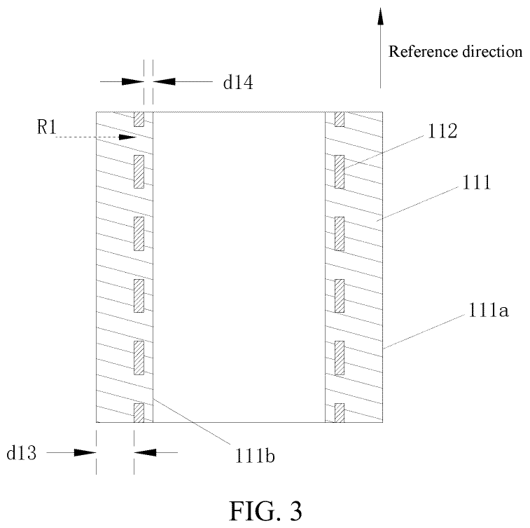

As shown in FIG. 3, a longitudinal extension length of the sensor 112 is substantially the same as a longitudinal extension length of the porous body 111. It should be noted that, the longitudinal extension direction is a reference direction shown in FIG. 3. The longitudinal extension direction may alternatively be an axial direction of the porous body 111 or the sensor 112. In some other examples, the longitudinal extension length of the sensor is less than the longitudinal length of the porous body 111. For example, a porous material completely covers a surface of the sensor, and the sensor does not completely extend to an end of the porous body in the longitudinal direction. This is beneficial for reducing metal overflow into the aerosol when the sensor is subjected to high temperature.

In a preferred implementation, the sensor 112 is arranged closer to the second surface than the first surface. In other words, a distance d13 between the sensor 112 and the liquid absorbing surface 111a is greater than a distance d14 between the sensor 112 and the atomization surface 111b. In a preferred implementation, the distance d13 between the sensor 112 and the liquid absorbing surface 111a is at least 2 to 5 times the distance d14 between the sensor 112 and the atomization surface 111b; or, at least 3 to 5 times the distance d14 between the sensor 112 and the atomization surface 111b; or, at least 4 to 5 times the distance d14 between the sensor 112 and the atomization surface 111b. In a preferred implementation, the distance d14 between the sensor 112 and the atomization surface 111b ranges from 0.1 mm to 0.4 mm, preferably, from 0.1 mm to 0.3 mm.

In this case, the porous body 111 may directly contact the liquid matrix through the liquid absorbing surface 111a and introduce the liquid matrix into the porous body 111. After passing through the liquid absorbing surface 111a, the liquid matrix is guided via the through holes 112a to reach the atomization surface 111b (indicated by R1 in the figure). When an alternating current is introduced to a magnetic field generator 21, the sensor 112 inside the atomization unit 11 is in an alternating magnetic field, to release a large amount of joule heat, to quickly atomize the liquid matrix on the atomization surface 111b to generate an aerosol for people to inhale. In some optional examples, the liquid absorbing surface 111a is covered or wrapped with a conductive dielectric layer (such as fiber cotton), and the liquid absorbing surface 111a of the porous body 111 indirectly contacts the liquid matrix through the conductive dielectric layer.

### Embodiment 2

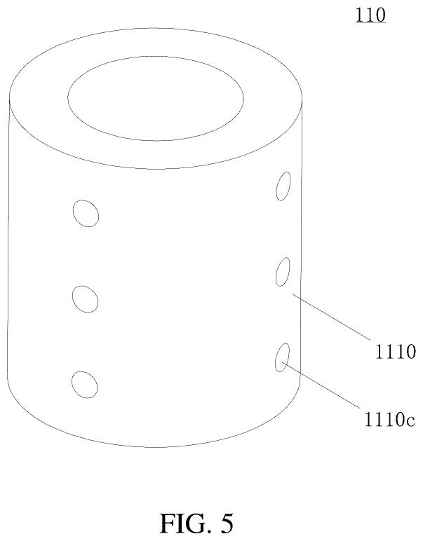

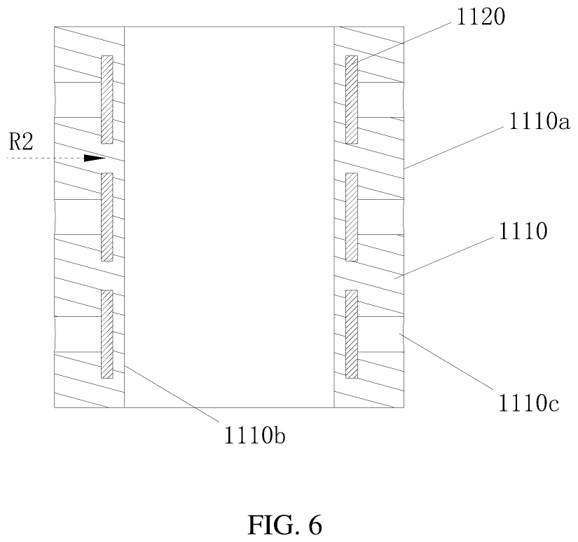

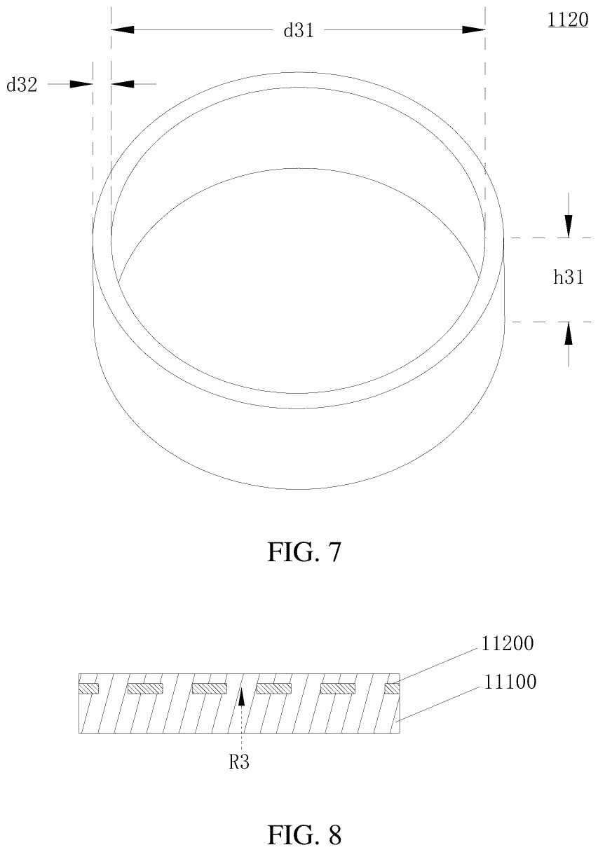

As shown in FIG. 5 to FIG. 7, another atomization unit 110 provided in implementations of this application is different from the examples in FIG. 2 to FIG. 4 in that:

the atomization unit 110 includes a plurality of sensors 1120 configured in a closed-loop tubular shape. A longitudinal (or an axial) extension length of each sensor 1120 is less than a longitudinal extension length of a porous body 1110. The plurality of sensors 1120 are arranged inside the porous body 1110 at intervals in a longitudinal (or an axial) direction of the porous body 1110. In a preferred implementation, spacing distances between neighboring sensors 1120 remain consistent. It may be understood that temperature distribution of the atomization unit 110 in the longitudinal (or the axial) direction may be changed by adjusting the spacing distances between the neighboring sensors 1120.

In a preferred implementation, the temperature distribution of the atomization unit 110 in the longitudinal (or the axial) direction may alternatively be changed by adjusting longitudinal extension lengths of the plurality of sensors 1120 or thicknesses of the plurality of sensors 1120. For example, in some examples, the atomization unit 110 includes three longitudinally distributed annular sensors 1120. Longitudinal lengths of two sensors near the end of the porous body 1110 are set to be greater than a longitudinal length of a sensor located in the middle of the porous body. In this case, when the atomization unit is in a same magnetic field area, the sensor in the middle generates less heat, to adjust heat distribution of an atomization surface of the porous body in a longitudinal direction, thereby achieving a balanced temperature field distribution area in the longitudinal direction of the atomization unit.

In examples of FIG. 5 to FIG. 7, the porous body 1110 further has an auxiliary hole 1110c. The auxiliary hole 1110c is configured to support the sensor 1120 during co-firing. It may be understood that, due to differences in a process and a mold, it is also feasible that the porous body does not have the auxiliary hole 1110c. An inner diameter d31 of the sensor 1120 ranges from 1 mm to 20 mm, a wall thickness d32 ranges from 0.1 mm to 2 mm, and a height h31 ranges from 0.1 mm to 30 mm.

In this case, a liquid absorbing surface 1110a may directly contact the liquid matrix or indirectly contact the liquid matrix through a cotton-wrapped structure, and the liquid matrix is guided into the liquid absorbing surface 1110a. After passing through the liquid absorbing surface 1110a, the liquid matrix passes through a gap between neighboring sensors 1120 and reaches an atomization surface 1110b (indicated by R2 in the figure), to further completely soak the atomization surface 1110b. When an alternating current is introduced to a magnetic field generator 21, the sensor 1120 inside the atomization unit 110 is in an alternating magnetic field, to release a large amount of joule heat, to quickly atomize the liquid matrix on the atomization surface 1110b to generate an aerosol for people to inhale.

### Embodiment 3

As shown in FIG. 8, in another embodiment, a sensor 11200 may be in a shape of a thin sheet. The sensor 11200 extends flatly between a liquid absorbing surface and an atomization surface of a porous body 11100, and is substantially parallel to the liquid absorbing surface and the atomization surface. A liquid matrix entering the porous body from the liquid absorbing surface is transferred to the atomization surface (indicated by R3 in the figure) via through holes or avoidance parts on the sensor. In some examples, the sensor 11200 includes a plurality of layers of metal sheets spaced longitudinally or transversely in the porous body.

It should be noted that, a magnetic field generator includes an induction coil. The induction coil may be a solenoid configured to surround the atomization unit. Specifically, the solenoid surrounds a periphery of the porous body, and the sensor and the induction coil are arranged substantially coaxially. The induction coil may alternatively be a flat coil configured to be substantially parallel to the sensor. In some examples, both the sensor and the porous body are loop-shaped, so that a through hole is configured at a center for airflow to flow through.

It should be noted that, the specification of this application and the accompanying drawings thereof illustrate preferred embodiments of this application. However, this application may be implemented in various different forms, and is not limited to embodiments described in this specification. These embodiments are not intended to be an additional limitation on the content of this application, and are described for providing a more thorough and comprehensive understanding of the content disclosed in this application. In addition, the foregoing technical features are further combined to form various embodiments not listed above, and all such embodiments shall be construed as falling within the scope of this application. Further, for a person of ordinary skill in the art, improvements or modifications may be made according to the above descriptions, and all these improvements and modifications shall fall within the protection scope of the appended claims of this application.

What is claimed is:

1. An aerosol generator suitable for a liquid matrix, comprising:
a liquid storage cavity configured to store a liquid matrix;
a magnetic field generator configured to generate a changing magnetic field when power is supplied; and
an atomization unit configured to atomize the liquid matrix to generate an aerosol,
wherein the atomization unit comprises:
a porous body, having a first surface and a second surface opposite to the first surface; and
at least one sensor, embedded in the porous body and located between the first surface and the second surface, wherein the sensor is configured to be penetrated by the changing magnetic field to generate heat, to atomize the liquid matrix, and
wherein the porous body is configured to absorb the liquid matrix through the first surface and guide the liquid matrix to pass through or avoid the sensor, to transfer toward the second surface.

2. The aerosol generator according to claim 1, wherein the sensor is arranged closer to the second surface than to the first surface.

3. The aerosol generator according to claim 2, wherein a distance between the sensor and the first surface is at least 2 to 5 times a distance between the sensor and the second surface.

4. The aerosol generator according to claim 1, wherein the sensor is configured in a closed-loop tubular shape.

5. The aerosol generator according to claim 4, wherein a longitudinal extension length of the sensor in the porous body is less than a longitudinal length of the porous body.

6. The aerosol generator according to claim 1, wherein the sensor has a plurality of through holes arranged at intervals, and at least part of the liquid matrix absorbed by the porous body through the first surface can be transferred toward the second surface through the through holes.

7. The aerosol generator according to claim 6, wherein apertures of the through holes are 0.1 mm to 0.5 mm.

8. The aerosol generator according to claim 6, wherein density of the through holes is uneven in a longitudinal direction of the sensor or the apertures of the through holes are inconsistent.

9. The aerosol generator according to claim 1, wherein the atomization unit comprises a plurality of sensors arranged at intervals in a longitudinal direction, and at least part of the liquid matrix absorbed by the porous body through the first surface can be transferred toward the second surface through gaps between neighboring sensors.

10. The aerosol generator according to claim 9, wherein at least two of the plurality of sensors have different longitudinal extension lengths or thicknesses.

11. The aerosol generator according to claim 1, wherein the magnetic field generator comprises an induction coil, and the induction coil is configured to surround the atomization unit, or the induction coil is configured as a flat coil and is arranged substantially parallel to the sensor.

12. An atomization unit for an aerosol generator, comprising:
a porous body, having a first surface and a second surface opposite to the first surface; and
at least one sensor, embedded in the porous body and located between the first surface and the second surface,
wherein the sensor is configured to be penetrated by the changing magnetic field to generate heat, to atomize the liquid matrix; and
wherein the porous body is configured to absorb the liquid matrix through the first surface and guide the liquid matrix to pass through or avoid the sensor, to transfer toward the second surface.
